(19) United States
(12) Patent Application Publication
(10) Pub. No.: US 2012/0320945 A1
(43) Pub. Date: Dec. 20, 2012

(54) ROBUST MEDIA SEALING TEMPERATURE PROBE

(75) Inventors: Brian Allen Engle, Armada, MI (US); David John Geer, Johnsonburg, PA (US); Ronald Anthony Martonik, Wilcox, PA (US)

(73) Assignee: GENERAL ELECTRIC COMPANY, Schenectady, NY (US)

(21) Appl. No.: 13/163,203

(22) Filed: Jun. 17, 2011

(51) Int. Cl. G01K 1/08; B23P 17/00; B29C 45/14

(52) U.S. Cl. 374/158; 264/272.15; 29/527.1; 374/E01.011

(57) ABSTRACT

A robust media sealing temperature probe is provided and includes a tubular member having a closed end and an open end opposite the closed end, an annular seal formed about the tubular member, a probe having a temperature sensing element and a signal conductive assembly coupled to the temperature sensing element, the probe being secured within the tubular member with the temperature sensing element proximate to the closed end and the signal conductive assembly extending through the open end and a housing formed to encapsulate the seal about the tubular member with the closed end and a portion of the signal conductive assembly exposed at an exterior of the housing.

### BACKGROUND OF THE INVENTION

The subject matter disclosed herein relates to a robust media sealing temperature probe.

Temperature sensing devices are commonly deployed in various applications, such as transportation applications, to assist in prevention of engine overheating, to provide accurate fluid temperature measurement to control various systems, such as fluid cooling systems, fuel systems, oil lubrication systems and hydraulic transmission systems, and to maintain system performance within established parameters.

Currently, automotive temperature sensors utilize sensing devices including thermocouples, negative temperature coefficient (NTC) thermistors and platinum resistance temperature table (RTD) elements. These devices include families of sensors whose characteristic electrical signal changes in a controlled manner in response to changes in the sensor temperature. These are typically provided in packages in which a thermally responsive electrical circuit is sealed from exposure to the environment to protect the sensing element from electrical shorts caused by conductive fluid and/or corrosion and chemical attack. Sealing is normally accomplished by coating the elements with epoxy, glass or other insulating media. Further protection for the electrical leads is often provided by encapsulating the sensor and its associated electrical circuit within a protective housing that isolates the sensor from the media or fluid to be measured.

Where temperature sensors are to be used in harsh environments, such as in engine intake manifolds, cooling systems, fuel systems or lubrication systems, they need to be protected from chemical attack as well as electrical shorts caused by humidity, water and other contaminants introduced from the environment into the electrical connection systems. Such protection cannot, however, impede the ability of the temperature sensors to exhibit fast and accurate responses to changes in temperature in the media to be measured.

In one protection solution that allows for fast response times, machined or drawn metal probes manufactured from materials with known robustness to chemical attack but with excellent heat transfer capabilities are used. Materials in this category include brass, plated mild steel and stainless steel. Temperature sensors using these materials also often utilize a terminated electrical connection whose shell is formed from a molded polymeric material. The electrical connection portion is typically mated to the metal probe portion via a roll-crimp constraint method utilizing a compressive seal to protect against water intrusion. This approach requires that the metal portion of the sensor housing extend through the manifold wall and into the ambient environment. While this approach allows for good thermal conduction between the media and the temperature sensing element, it allows heat transfer between the sensor housing and the fluid manifold walls as well as the ambient environment. The net result is a “stem effect” that biases the sensor reading to be dependent upon the influence of temperature conditions at the manifold wall and the ambient environment that the exposed portion of the metal housing experiences.

Installation of alternative types of assemblies may be accomplished using either a twist lock mechanism or, more commonly, a threaded connection that includes a secondary seal, such as an O-ring or metal washer. In these applications, the probe, threaded section, and hexagonal section used for securing the sensor using a wrench are commonly formed from a single piece of machined metal. While this configuration is sufficient to protect the temperature sensor from both media attack and external water ingress, these designs have the undesired affect of thermally sinking the sensor, resulting in sensing errors attributable to the transfer of heat to and from the outside environment into the probe shell which contains the temperature sensing element. These machined metal housings also exhibit the undesired properties of having a large thermal mass relative to the sensing element, as well as relatively thick walls interspersed between the sensing element and the sensed media, resulting in slower response times to changes in media temperature and decreased accuracy caused by the exposure of the metal shell to the manifold and the ambient environment.

### BRIEF DESCRIPTION OF THE INVENTION

According to one aspect of the invention, a robust media sealing temperature probe is provided and includes a tubular member having a closed end and an open end opposite the closed end, an annular seal formed about the tubular member, a probe having a temperature sensing element and a signal conductive assembly coupled to the temperature sensing element, the probe being secured within the tubular member with the temperature sensing element proximate to the closed end and the signal conductive assembly extending through the open end and a housing formed to encapsulate the seal about the tubular member with the closed end and a portion of the signal conductive assembly exposed at an exterior of the housing.

According to another aspect of the invention, a robust media sealing temperature probe assembly is provided and includes a manifold wall formed to define a pathway therein through which media flows from an upstream end thereof to downstream end thereof, the manifold wall having an aperture and a temperature probe operably disposed within the aperture, the temperature probe including a tubular member having a closed end and an open end opposite the closed end, an annular seal formed about the tubular member, a probe having a temperature sensing element and a signal conductive assembly coupled to the temperature sensing element, the probe being secured within the tubular member with the temperature sensing element proximate to the closed end and the signal conductive assembly extending through the open end and a housing supported within the aperture and formed to encapsulate the seal about the tubular member with the closed end exposed to the media and a portion of the signal conductive assembly exposed at an exterior of the manifold wall.

According to yet another aspect of the invention, a method of assembling a robust media sealing temperature probe is provided and includes molding an annular elastomeric material seal proximate to an open end of a metallic tubular member having a closed end opposite the open end, potting a probe having a temperature sensing element and a signal conductive assembly coupled to the temperature sensing element in the tubular member such that the temperature sensing element is disposed proximate to the closed end and the signal conductive assembly extends through the open end and overmolding a polymeric housing to compress the seal about the tubular member such that the closed end and a portion of the signal conductive assembly are exposed at an exterior of the housing.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a side schematic view of a temperature probe assembly;

FIGS. 2-4 illustrate a method of forming components of the temperature probe assembly of FIG. 1; and

FIG. 5 is a schematic view of the temperature probe assembly according to alternative embodiments.

The detailed description explains embodiments of the invention, together with advantages and features, by way of example with reference to the drawings.

### DETAILED DESCRIPTION OF THE INVENTION

In accordance with aspects, a temperature sensor quickly and accurately measures temperature of media with minimal influence of the manifold constraining the fluid media or the external environment on the temperature of the sensor element. Material selection to accomplish this couples the thermal performance of a low mass metal probe with the insulating effects of a polymeric housing. The substantial differences in coefficient of thermal expansion between the selected materials of the polymeric housing and the metal probe would normally contribute to a fluid ingress path into the electrical portion of the sensor and ultimate failure of the device, but in this invention are accommodated by a robust probe-to-housing sealing surface, which allows for thermal insulation from the outside environment while providing fast, accurate data on the temperature of the media. The robust sealing surface may be provided for by an intermediate, media resistant sealing material that is molded directly to the metal probe in an annular seal geometry and subsequently overmolded with the polymeric housing. The flow of the polymeric material around the seal encapsulates the seal material, forming a seal gland and providing compressive force on the sealing material to prevent fluid ingress. Injection pressures of the molding process provide a substantially uniform, compressive seal force around the elastomeric seal during the molding and cooling process. By providing a stable, substantially uniform compression on the annular seal during the molding process, the seal is trapped permanently between the metal probe and the polymeric housing. The forms a robust, long-life seal that is resistant to fluid ingress, media attack, and coefficient of thermal expansion differences between the probe and the housing.

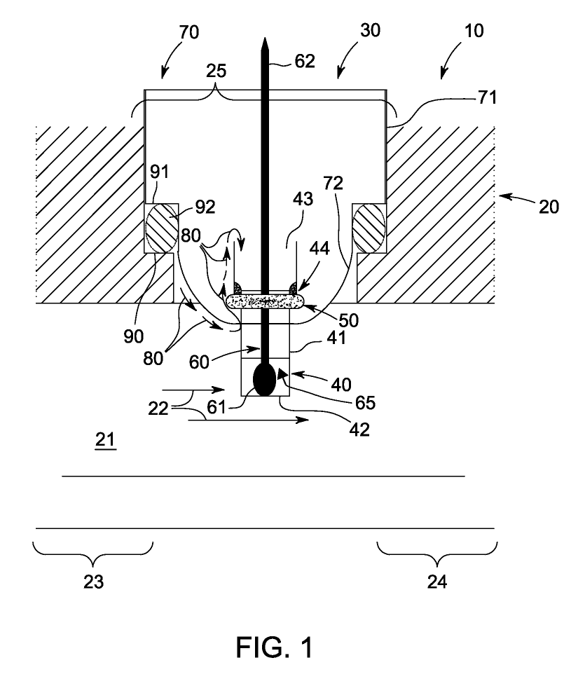

With reference to FIG. 1, a temperature probe assembly 10 is provided. The temperature probe assembly 10 includes a manifold wall 20 and a temperature probe 30. The manifold wall 20 is formed to define a pathway 21 therein through which media 22 flows from an upstream end 23 thereof to a downstream end 24 thereof The manifold wall 20 also has an aperture 25 formed therein by which a condition of the media 22 (i.e., a temperature of the media 22) can be sensed by the temperature probe 30.

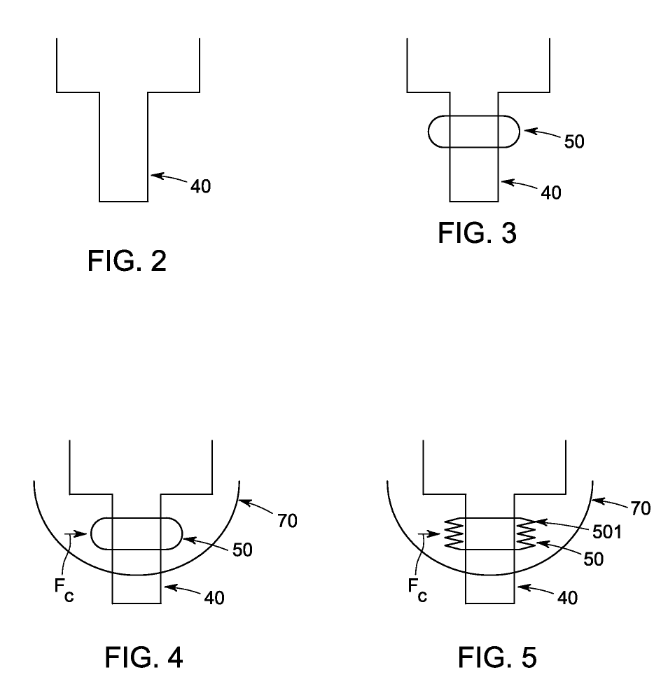

The temperature probe 30 may be operably disposed within the aperture 25 as will be described below to sense the condition of the media 22. The temperature probe 30 includes a generally tubular member 40, an annular seal 50, a probe 60 and a housing 70 that is formed to compress the seal 50 toward the tubular member 40 and, in some cases, to apply a compressive to the tubular member 40. The tubular member 40 has an annular sidewall 41 with a closed end 42 and an open end 43 opposite the closed end 42. The annular sidewall 41 may be formed as a single cylindrical section or with a step formation 44 (see FIG. 2) or another similar type of surface irregularity to improve retention in the housing 70. The tubular member 40 may be formed from any one or more of various metallic or metal alloy materials, such as brass, plated mild steel or stainless steel with the general goal of providing the tubular member 40 with generally high thermal conductivity, relatively low thermal mass as compared to the probe 60 and with resistance to chemical attack from the media 22 (i.e., corrosion resistance).

The coefficient of thermal expansion of the tubular member 40 may be similar to or different from that of the housing 70. The seal 50 is thus formed about the tubular member 40 at or proximate to the open end 43 to provide for any required mechanical and thermal expansion compliance between the tubular member 40 and the housing 70. Where the tubular member 40 is circular or elliptical, the seal 50 should be correspondingly circular or elliptical and formed circumferentially around the tubular member 40. In an exemplary embodiment, the seal 50 may be formed as an o-ring or with a semi-circular cross-section having a flat interior diameter to mate with the sidewall 41 (see FIG. 3). Where the annular sidewall 41 is formed as a straight cylindrical section or with a step formation 44 or another type of surface irregularity to provide retention functionality in the housing 70, the seal 50 may be provided nearby to increase a size or area of the seal surface between the seal 50 and the tubular member 40. In accordance with further embodiments, a cross-section of the seal 50 may be elongated and formed to extend longitudinally along the annular sidewall 41. In addition, the cross-section of the seal 50 may include ribs 501 (see FIG. 5), grooves or other similar types of features on either the tubular member 40 side (i.e., the inner side) or the housing 70 side (i.e., the outer side).

The seal 50 may be formed of various compliant materials, such as, but not exclusively, elastomeric materials. In this way, the seal 50 provides for any of the required mechanical and thermal compliance between the tubular member 40 and the housing 70 under various temperature conditions so as to prevent fluid intrusion into the sensor probe assembly

The probe 60 may be formed as one or more of a thermocouple, a thermistor, a negative temperature coefficient (NTC) thermistor and a platinum resistance temperature table (RTD) element. In any case, the probe 60 has a temperature sensing element 61 and a signal conductive assembly 62 coupled to the temperature sensing element 61. The signal conductive assembly 62 may be wiring formed of nickel (Ni) or another similar material and may have relatively small diameters to limit heat transfer along at least a longitudinal axis thereof. The probe 60 is secured in the tubular member 40 by cured epoxy resin or another similar material with the temperature sensing element 61 securely disposed proximate to the closed end 42 and the signal conductive assembly 62 permitted to extend through the open end 43 and the seal 50. The epoxy resin may be provided proximate to the closed end 42 or may fill the tubular member 40 to the open end 43.

Thermal grease 65 or thermal potting material may be interposed at least between the closed end 42 and the temperature sensing element 61 to increase thermal conduction between the media 22, the closed end 42 and the temperature sensing element 61.

With the construction described above, the temperature probe 30 exhibits relatively high thermal conductivity between the media 22, the tubular member 40 and the probe 60. Meanwhile, since the amount of efficiently thermally conductive material is substantially limited to the tubular member 40 and the probe 60, the temperature probe 30 as a whole performs condition measurements with limited thermal influence from the temperature of the environment or from the manifold wall 20.

As shown in FIG. 1, the housing 70 is mechanically supportable within the aperture 25 or otherwise affixed therein and is formed to compress the seal 50 about the tubular member 40 with the closed end 42 exposable to the media 22 and a length or a portion of the signal conductive assembly 62 exposable at an exterior of the manifold wall 20. The housing 70 may be formed of polyamide material, similar polymeric material or another similar material and may have an annular shape that encapsulates the media-resistant fluid seal 50 within the confines of the housing and a non-exposed portion of the tubular member 40. In an embodiment, the housing 70 may include an annular head portion 71 and a tapered annular neck portion 72 that tapers toward the annular sidewall 41 of the tubular member 40. Other interface geometries, including a hemispherical or other geometry may be employed dependent upon package design constraints and the relative diameters of the tubular member 40 and the housing 70. All housing geometries provide complete encapsulation of the fluid seal axially and longitudinally.

With reference to FIGS. 2-4, a method of forming the above-described components of the temperature probe assembly 10 is illustrated. As shown in FIGS. 2 and 3, the seal 50 is provided about the tubular member 40. Then, as shown in FIG. 4, the housing is formed about the seal 50 and the tubular member 40.

As the housing 70 is formed, the flow of material for the housing 70 exerts a compressive load (Fₑ) on the seal 50 and provides both a sealing surface and compressive load on the seal 50. Separate molding of the seal 50 onto the tubular member 40 provides sealing between the seal 50 and the tubular member 40. The cross-section of the seal 50 may be semicircular, triangular, ribbed or may be provided with other geometry known to provide sealing surfaces that limit risks of fluid passing between the outside edge of the seal 50 and the inside mating surface of the housing 70. In addition, where the housing 70 directly contacts the annular sidewall 41, an additional mechanical seal may be formed between the housing 70 and the annular sidewall 41. With this construction and with reference back to FIG. 1, ingress of contaminants or moisture from the external environment must follow a torturous and extremely restrictive path 80 to the internal portion of the probe 60 along an exterior of the housing 70, between the housing 70 and the annular wall 41, past the seal 50 and then through the open end 43. Where the annular wall 41 is formed with a step formation 44 or another similar type of surface irregularity, the torturous path 80 can be made increasingly difficult to traverse. This substantially reduces the risk of fluid ingress causing a failure of the electrical portion of the temperature sensing element 61.

Once formed, the molded housing 70 can also be cut, machined or otherwise shaped to precisely fit into the aperture 25 to limit an amount of space between the manifold wall 20 and the housing 70. For example, where the aperture 25 is circular having a given diameter, the housing 70 may be cut to be circular with an outer diameter that is very similar to the diameter of the aperture 25.

In addition, as shown in FIG. 1, the manifold wall 20 may be formed with a step formation 90 at the aperture 25 on which the housing 70 may be supported. In this case, the housing 70 may also include a step formation 91 that complements the step formation 90 of the manifold wall 20. Moreover, an o-ring seal 92 may be interposed between the respective step formations 90, 91 of the manifold wall 20 and the housing 70 to increase a seal between the housing 70 and the manifold wall 20. In these cases, the torturous path 80 is extended further and ingress of contaminant or moisture from the external environment is increasingly prevented.

In accordance with aspects and with particular reference to FIGS. 2-4, a method of assembling a temperature probe 30 of a temperature probe assembly 10 is provided. The method includes molding the elastomeric material seal 50 to the open end 43 of a metallic tubular member 40 that has a closed end 42, which is opposite the open end 43. The method then includes potting a probe 60 having a temperature sensing element 61 and the signal conductive assembly 62 coupled to the temperature sensing element 61 in the tubular member 40 such that the temperature sensing element 61 is disposed proximate to the closed end 42 and the signal conductive assembly 62 extends through the open end 43 and the seal 50 and overmolding a polymeric housing 70. The overmolding serves to compress the seal 50 about the tubular member 40 such that the closed end 42 and a portion or length of the signal conductive assembly 62 are respectively exposed at an exterior of the housing 70. Thermal grease 65 may be provided between at least the closed end 42 and the temperature sensing element 61.

The housing 70 can then be cut, machined and/or shaped to size and supported in the aperture 25 of the manifold wall 20 such that the closed end 42 is exposed to the media 22 flowing through the pathway 21, which is defined through the manifold wall 20.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A robust media sealing temperature probe, comprising:
a tubular member having a closed end and an open end opposite the closed end;
an annular seal formed about the tubular member;
a probe having a temperature sensing element and a signal conductive assembly coupled to the temperature sensing element, the probe being secured within the tubular member with the temperature sensing element proximate to the closed end and the signal conductive assembly extending through the open end; and
a housing formed to encapsulate the seal about the tubular member with the closed end and a portion of the signal conductive assembly exposed at an exterior of the housing.

2. The temperature probe according to claim 1, wherein the tubular member comprises a step formation.

3. The temperature probe according to claim 1, wherein the tubular member comprises a metal, a metal alloy or a material of known high thermal conductivity.

4. The temperature probe according to claim 1, wherein the tubular member comprises one or more of brass, plated mild steel and stainless steel.

5. The temperature probe according to claim 1, wherein the tubular member and the housing are formed of materials having different coefficients of thermal expansion.

6. The temperature probe according to claim 1, further comprising epoxy resin to secure the probe within the tubular member and the seal.

7. The temperature probe according to claim 1, further comprising thermal grease interposed between the closed end and the temperature sensing element.

8. The temperature probe according to claim 1, wherein the probe comprises a thermistor.

9. The temperature probe according to claim 1, wherein the signal conductive assembly comprises nickel, stainless steel or a material of known high electrical conductivity and low thermal conductivity.

10. The temperature probe according to claim 1, wherein the seal comprises a compliant material.

11. The temperature probe according to claim 1, wherein a cross-sectional shape of the seal is semicircular, triangular or ribbed.

12. The temperature probe according to claim 1, wherein the seal comprises a elastomeric material.

13. The temperature probe according to claim 1, wherein the housing comprises a polymeric material.

14. The temperature probe according to claim 1, wherein the housing comprises a polyamide material-based material.

15. A robust media sealing temperature probe assembly, comprising:
a manifold wall formed to define a pathway therein through which media flows from an upstream end thereof to downstream end thereof, the manifold wall having an aperture; and
a temperature probe operably disposed within the aperture, the temperature probe comprising:
a tubular member having a closed end and an open end opposite the closed end;
an annular seal formed about the tubular member;
a probe having a temperature sensing element and a signal conductive assembly coupled to the temperature sensing element, the probe being secured within the tubular member with the temperature sensing element proximate to the closed end and the signal conductive assembly extending through the open end; and
a housing supported within the aperture and formed to encapsulate the seal about the tubular member with the closed end exposed to the media and a portion of the signal conductive assembly exposed at an exterior of the manifold wall.

16. The temperature probe assembly according to claim 15, wherein the manifold wall is formed with a step formation at the aperture on which the housing is supported and the housing comprises a step formation that complements the step formation of the manifold wall.

17. The temperature probe assembly according to claim 16, further comprising a seal interposed between the step formations of the manifold wall and the housing.

18. A method of assembling a robust media sealing temperature probe, comprising:
molding an annular elastomeric material seal proximate to an open end of a metallic tubular member having a closed end opposite the open end;
potting a probe having a temperature sensing element and a signal conductive assembly coupled to the temperature sensing element in the tubular member such that the temperature sensing element is disposed proximate to the closed end and the signal conductive assembly extends through the open end; and
overmolding a polymeric housing to compress the seal about the tubular member such that the closed end and a portion of the signal conductive assembly are exposed at an exterior of the housing.

19. The method according to claim 18, further comprising providing thermal grease between the closed end and the temperature sensing element.

20. The method according to claim 18, further comprising cutting, machining and/or shaping the housing.
